(19) United States
(12) Patent Application Publication
(10) Pub. No.: US 2026/0320392 A1
(43) Pub. Date: Oct. 15, 2026

(54) Scaling Neural Network Architectures to Computational Resource Constraints

(71) Applicant: Google LLC, Mountain View, CA (US)

(72) Inventors: Ibrahim Alabdulmohsin, Cham (CH); Alexander Kolesnikov, Zürich (CH); Lucas Klaus Beyer, Zürich (CH); Xiaohua Zhai, Zürich (CH)

(21) Appl. No.: 19/485,257

(22) PCT Filed: Aug. 8, 2023
(86) PCT No.: PCT/US2023/029718

§ 371 Date: Nov. 17, 2025

Related U.S. Application Data
(60) Provisional application No. 63/502,790, filed on May 17, 2023.

(51) Int. Cl. G06N 3/082; G06N 3/045

(52) U.S. Cl. CPC G06N 3/082; G06N 3/045

(57) ABSTRACT

There is disclosed a computer-implemented method for determining a neural network architecture according to a given computational resource constraint. The method comprises, for each of one or more neural network architecture dimensions that are to be adjusted: determining a power law function for the architecture dimension based upon a first plurality of neural network performance evaluations on a machine learning task using a plurality of differently scaled neural networks, the plurality of differently scaled neural networks having the same neural network architecture except for a different value in the architecture dimension; wherein the power law function is a function of a performance metric on the machine learning task with respect to the architecture dimension and computational resource utilization; and determining a scaling exponent for the architecture dimension based upon the determined power law function.

### RELATED APPLICATIONS

This application claims priority to and the benefit of U.S. Provisional Patent Application No. 63/502,790, filed May 17, 2023. U.S. Provisional Patent Application No. 63/502,790 is hereby incorporated by reference in its entirety.

### TECHNICAL FIELD

This specification relates to systems and methods for determining neural network architectures for a given computational resource constraint.

### BACKGROUND

Neural networks comprise a plurality of parameters organized into a set of hierarchical layers. Each layer may comprise the same or a different number of parameters and may carry out the same or a different function. There exist many different possible choices of neural network architecture. How to determine the architecture or shape of a neural network remains an open problem.

### SUMMARY

According to a first aspect, there is provided a computer-implemented method for determining a neural network architecture according to a given computational resource constraint. The method comprises, for each of one or more neural network architecture dimensions that are to be adjusted: determining a power law function for the architecture dimension based upon a first plurality of neural network performance evaluations on a machine learning task using a plurality of differently scaled neural networks, the plurality of differently scaled neural networks having the same neural network architecture except for a different value in the architecture dimension; wherein the power law function is a function of a performance metric on the machine learning task with respect to the architecture dimension and computational resource utilization; and determining a scaling exponent for the architecture dimension based upon the determined power law function.

The method further comprises determining a base neural network architecture based upon a second plurality of neural network performance evaluations on the machine learning task using a plurality of candidate neural networks, the plurality of candidate neural networks having been trained according to a smaller computational resource constraint than the plurality of differently scaled neural networks; wherein the plurality of candidate neural networks have different architectures.

The method further comprises modifying the one or more architecture dimensions of the base neural network architecture based upon the corresponding scaling exponents, a computational resource utilization of the base neural network architecture and the given computational resource constraint to provide an output neural network architecture.

According to a further aspect, there is provided a system comprising one or more processors and one or more computer readable storage media comprising processor readable instructions to cause the one or more processors to carry out an above method aspect.

According to another aspect, there is provided one or more non-transitory computer readable storage medium comprising instructions which, when executed by a computer, cause the computer to carry out an above method aspect.

It will be appreciated that features disclosed in the context one aspect may be combined with features disclosed in the context of one or more other aspects.

### BRIEF DESCRIPTION OF THE DRAWINGS

FIG. 1 is a schematic illustration of an exemplary system for determining a neural network architecture according to a given computational resource constraint.

FIG. 2 is a flowchart showing exemplary processing for determining a neural network architecture according to a given computational resource constraint.

FIG. 3 is a schematic illustration of an exemplary computing system.

Like reference numbers and designations in the various drawings indicate like elements.

### DETAILED DESCRIPTION

Prior work has attempted to investigate the scaling behaviour of neural networks. That is, how neural network performance changes as the number of parameters, the size of dataset or computational resource utilization for training or inference increases. In particular, for Transformer-based language models, it has been empirically found that upstream performance follows a power law scaling as the number of parameters in the network varies. These results however do not consider the specific architecture of the neural network and only the total number of parameters.

The scaling behaviour for computational resource utilization is also more complicated. It is possible that increasing the computational resource budget for training can actually be detrimental to the performance of the neural network. Typically, one has a computational resource budget in mind for training and it can be difficult to determine what architecture would be most optimal for the given computational resource budget.

Described herein is a two-stage process for determining an optimal neural network architecture according to a given computational resource constraint. In particular, a power law formulation that takes into account both the variation in an architecture dimension and the computational resource utilization is used. The first stage attempts to determine this power law relationship for each variable architecture dimension from a first plurality of neural network performance evaluations using a first plurality of neural networks. These neural networks have the same architecture except for the dimension under investigation (and hence may be referred to herein as differently scaled neural networks). A scaling exponent for the dimension can then be derived from the power law relationship.

For example, in a Transformer-type of neural network, the architecture dimensions may include a depth (e.g. the number of Transformer blocks), a width (e.g. the embedding dimension of input tokens), and an MLP size (e.g. the size of the MLP layer in a Transformer block).

In some implementations, the computational resource constraint relates to an available amount “compute” or in other words, a computational resource budget. Compute (including computational resource constraints/budget/utilization) may be defined/measured based upon a number of floating-point operations per second (FLOPS) and/or other suitable measure(s).

In the second-stage (though it will be appreciated that the two stages can be carried out in any order or concurrently), a base neural network architecture is determined from a second plurality of neural network performance evaluations using a second plurality of so neural networks (which may be referred to as candidate neural networks). These candidate neural networks in the second-stage are typically much smaller than in the first stage so that they can be trained using small computational resource budgets. In this regard, the candidate neural networks can be trained according to a smaller computational resource constraint than all of the neural networks in the first-stage. As such, this second-stage process may run faster than the first-stage process even if there are a greater number of neural networks overall in the second-stage than in the first.

The aim of the second stage is to determine an optimal (or near-optimal) base neural network architecture for scaling to the given computational resource constraint. In the second stage, a conventional grid search may be used to determine the base neural network architecture.

The scaling exponent determined in the first stage can then be used to scale up the relevant dimensions of the base neural network architecture based upon the given computational resource constraint and the computational resource utilization of the base neural network architecture. For example, a scale factor between the given computational resource constraint and the computational resource utilization of the base neural network architecture can be determined. This scale factor can be exponentiated according to an exponent based upon the scaling exponent. The corresponding architecture dimension of the base neural network can be scaled by the exponentiated scale factor.

Despite the relative independence of the two-stages, a well-performing neural network architecture can be determined. For example, using the described process, a Vision Transformer having its depth, width and MLP size optimized has competitive image classification performance compared to a prior art Vision Transformer with 2.5 times more parameters and trained using the same computational resource budget. As such, the described techniques can determine more optimal architectures that have fewer parameters and therefore consumes fewer computational resources at inference time.

Additionally, the described two-stage process is more efficient, in some cases by an order of magnitude, than prior works that attempt to discover scaling relationships. For example, in prior work 400 training runs may be required to optimize a single dimension whilst using the present techniques, 115 training runs across both stages may be sufficient to optimize three dimensions.

As discussed above, there is typically a given computational resource constraint which may be dictated by the particular computing hardware available. For example, the computational resource constraint/utilization may be for specific computing hardware such as computing hardware comprising one or more Tensor Processing Units (TPUs), Graphics Processing Units (GPUs), Central Processing Units (CPUs), Application Specific Integrated Circuits (ASICs), and/or Field Programmable Gate Arrays (FPGAs). The computing hardware may operate as a distributed system.

The method may include training a neural network model having the output neural network architecture using the particular computing hardware and/or executing the neural network model having the output neural network architecture using the particular computing hardware.

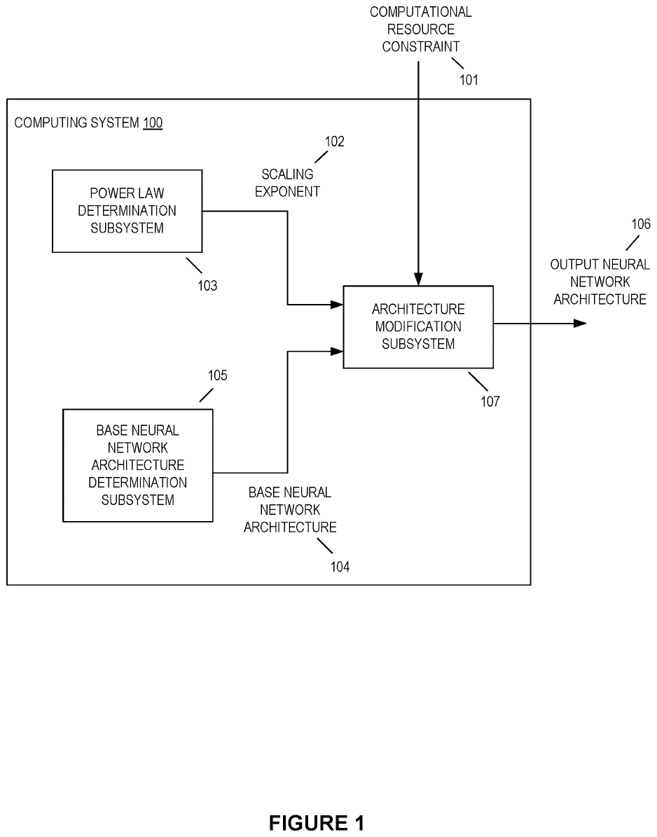

Referring now to FIG. 1, there is depicted an exemplary computing system 100 for determining a neural network architecture according to a given computational resource constraint 101. The computing system 100 may comprise one or more processors located in one or more locations. The computing system 100 may comprise a server, desktop computer, a mobile device such as a laptop, smartphone or tablet, or any other suitable computing apparatus. The computing system 100 may be a distributed system.

As discussed above, the computational resource constraint 101 may relate to an available amount of “compute” and may define a computational resource budget. Compute may be defined/measured based upon a number of floating-point operations per second (FLOPS) and/or other suitable measures such as a wall-clock time or TPU core hours. The computational resource constraint 101 may refer to the resources available for training a neural network or the resources available at inference when using the neural network. The computational resource constraint 101 may be specific to particular hardware used for training the neural network or the particular hardware that the neural network is to be deployed on. For example, the computational resource constraint 101 may be for specific computing hardware such as computing hardware comprising one or more Tensor Processing Units (TPUs), Graphics Processing Units (GPUs), Central Processing Units (CPUs), Application Specific Integrated Circuits (ASICs), and/or Field Programmable Gate Arrays (FPGAs).

The computational resource constraint 101 may be provided by a user. The system 100 may be configured to receive the computational resource constraint 101 locally or remotely. In the latter case, the computational resource constraint 101 may be received by the system 100 over any suitable network connection.

In general, the system 100 is configured to determine an appropriate value according to the given computational resource constraint 101 for each of one or more adjustable neural network architecture dimensions. For example, the neural network architecture dimensions may include a width, such as the number of neurons in a hidden layer or more specifically, for a Transformer-type neural network, the width may be the embedding dimension of input tokens. In addition, or alternatively, the neural network architecture dimensions may include a depth, such as the number of layers in the neural network. For a Transformer-type neural network, the depth may refer to the number of Transformer blocks. For a Transformer-type neural network, the neural network architecture dimensions may include an MLP size, that is, the size of the MLP layer in a Transformer block. Other neural network architecture dimensions may include the size of convolution kernels in a Convolutional Neural Network or the size of a memory cell in an LSTM unit amongst others. Which neural network architecture dimensions are to be adjusted may be specified by a user of the system 100 or may be pre-determined according to the neural network type for example. It is possible that only a subset of the possible architecture dimensions of a neural network are to be adjusted according to the given computational resource constraint 101. The other architecture dimensions that are not adjusted may be set to a fixed user specified value or may be set to a pre-determined default value for example.

The system 100 is configured to determine a power law function for each adjustable architecture dimension based upon a first plurality of neural network performance evaluations on a machine learning task using a plurality of differently scaled neural networks. As explained in more detail below, the power law function is a function of a performance metric on the machine learning task with respect to the architecture dimension and computational resource utilization. In other words, the power law function provides an estimate of how the architecture dimension scales with performance whilst also accounting for computational resource utilization. Determining the power law function may comprise estimating the parameters of the power law function.

The plurality of differently scaled neural networks have the same neural network architecture except for a different value in the particular architecture dimension. The different values of the architecture dimension may be exponentially spaced apart. For example, an architecture dimension under consideration may be the MLP size of a Transformer block. The values for the MLP size of the differently scaled neural networks may include 1088, 1360, 1728, 2160, 2592 and 3072 corresponding to about a 20% increase in each step. The other architecture dimensions such as the width may be fixed at 1968 and the depth fixed at 40 for each of the plurality of differently scaled neural networks. In another example, the depth of a Transformer block is an architecture dimension under consideration. The values for the depth of the differently scaled neural networks may include 8, 10, 12, 16, 20 and 24 with the width fixed at 1968 and MLP size fixed at 6144 for each of the plurality of differently scaled neural networks. In a further example, the width of a Transformer block is an architecture dimension under consideration. The values for the width of the differently scaled neural networks may include 608, 768, 928, 1088, 1328 and 1648 with the depth fixed at 40 and MLP size fixed at 6144 for each of the plurality of differently scaled neural networks.

For all of the adjustable architecture dimensions, the plurality of differently scaled neural networks may be based upon modifying the same starting architecture. That is, a starting architecture may be selected and a single dimension is modified each time whilst the remaining dimensions are held fixed as can be seen from the examples above. Thus, a “star sweep” may be conducted as compared to a grid-search or random-search.

The starting architecture may correspond to a “large” model whilst the dimension values used for the plurality of differently scaled neural networks are selected to be smaller than the corresponding dimension value of the starting architecture. This is to ensure that the other (fixed) dimensions do not form a bottleneck when estimating the parameters of the power law function. In one example, the starting architecture is a Transformer having a width of 1968, depth of 40 and MLP size of 6144. The starting architecture may be selected according to any suitable method, for example, selection may be based upon computational resources available for carrying out this stage of the process.

The machine learning task used for determining the power law function may be any suitable machine learning task of interest. For example, the machine learning task may so be an image classification task, an image captioning task, an optical character recognition task, or a panoptic segmentation task. Further suitable example machine learning tasks are described below. The performance metric may be any suitable performance metric according to the machine learning task. In some cases, the performance metric may relate to an upstream or downstream task. For example, a neural network may be pre-trained using unsupervised or self-supervised learning before undergoing training for a specific task that the neural network is to be deployed on. The pre-training task is typically referred to as the upstream task. The subsequent task that the neural network is to be deployed on is referred to as the downstream task. It may be preferrable to use the downstream task as the performance metric when determining the power law function as this may provide a better indicator of final performance of the neural network than its upstream task performance. It is also likely that the power law function will differ when estimated from the upstream or downstream performance metric. Prior techniques however have typically used the upstream performance metric for estimating a power law function.

The system 100 may be configured to train the plurality of differently scaled neural networks on the machine learning task. Alternatively, a separate system may be used to train the plurality of differently scaled neural networks. The first plurality of neural network evaluations used for determining the power law function may be carried out at the end of training or may be carried out at different stages throughout the training process. The same computational resource budget may be used for training all of the differently scaled neural networks. The same computational resource budget may also be used for training all of the differently scaled neural networks for all of the dimensions under consideration. The training of the plurality of differently scaled neural networks may follow conventional neural network training procedures for the particular machine learning task as deemed appropriated by a person skilled in the art.

For example, stochastic gradient descent may be used to update the weights of a neural network during training. For image classification, the ImageNet dataset may be used for training. For image captioning or segmentation, the COCO dataset may be used for training. Other datasets may be used as appropriate.

The system 100 is further configured to determine a scaling exponent 102 for the architecture dimension based upon the determined power law function. As described in more detail below, the scaling exponent 102 may be based upon a ratio of the plurality of exponents in the determined power law function.

The system 100 may comprise a power law determination subsystem 103 for determining the power law function and the scaling exponent 102.

The system 100 is further configured to determine a base neural network architecture 104 based upon a second plurality of neural network performance evaluations on the machine learning task using a plurality of candidate neural networks. The plurality of candidate neural networks have different architectures and the plurality of candidate neural networks have been trained according to a smaller computational resource constraint than the plurality of differently scaled neural networks. As discussed above, the aim of this stage is to determine an optimal (or near-optimal) base neural network architecture for scaling to the given computational resource constraint 101. In this regard, a grid search may be used to select the architectures and/or the computational resource constraints for the plurality of candidate neural networks. In particular, it is preferrable that the plurality of candidate of neural networks are much smaller than the plurality of differently scaled neural networks used for determining the power law function. This is so that a greater number of candidate neural networks may be evaluated in order to determine an optimal base neural network architecture. An optimal base neural network architecture may be one that lies in the Pareto optimal frontier with respect to performance and computational resource utilization (compute). Compute-optimal architectures typically follow power law scaling and thus provides a better base architecture for scaling up using the determined power law function and scaling exponent 102. In one example, the base neural network architecture of a Transformer type neural network has a width of 608, a depth of 10 and an MLP size of 928.

The system 100 may comprise a base neural network architecture determination subsystem 105 for determining the base neural network architecture 104.

The system 100 may be configured to train the plurality of candidate neural networks on the machine learning task. Alternatively, a separate system may be used to the train the plurality of candidate neural networks. In some implementations, the plurality of candidate neural networks are first pre-trained on a different machine learning task. The plurality of candidate neural networks may then be fine-tuned on the (downstream) machine learning task. For example, a Transformer type neural network is typically pre-trained using unsupervised/self-supervised learning tasks then fine-tuned on a supervised downstream task. The plurality of candidate neural network evaluations may be evaluated at the end of training or may be carried out at different stages throughout the training process. As previously, the training may follow conventional neural network training procedures for the particular machine learning task and use appropriate training datasets.

The system 100 is further configured to modify the one or more architecture dimensions of the base neural network architecture 104 based upon the corresponding scaling exponents 102, a computational resource utilization of the base neural network architecture 104 and the given computational resource constraint 101 to provide an output neural network architecture 106. As described in more detail below, the system 100 may be configured to determine a compute scale factor based upon the ratio of the given computational resource constraint 101 and the computational resource utilization of the base neural network architecture. The system 100 may be further configured to determine a dimensional scale factor based upon taking an exponential of the compute scale factor with an exponent based upon the scaling exponent 102. The exponent may be based upon the value of the scaling exponent 102 divided by the number of adjustable architecture dimensions. In other implementations, the raw value of the scaling exponent 102 may be used. The system 100 may be further configured to modify the value of the corresponding architecture dimension of the base neural network architecture 104 by the dimensional scale factor.

The system 100 may comprise an architecture modification subsystem 107 for modifying the base neural network architecture 104 to provide an output neural network architecture 106.

The system 100 may be further configured to train a neural network having the architecture of the output neural network architecture 106. The neural network may be trained on the same machine learning task used for determining the output neural network architecture 106. Once trained, the neural network may then be deployed. The system 100 may be configured to transmit the trained neural network to another system for use/deployment, for example on one or more user devices. Alternatively, the system 100 may be configured to deploy and allow access to the neural network itself, for example through a set of application programming interfaces (APIs). If the given computational resource constraint 101 relates to a specific target hardware, the neural so network may be deployed on that target hardware.

When the neural network is deployed on an image processing task, the system 100 (or any other system/device that the neural network is deployed on) may be configured to receive image data and to process the image data using the neural network to generate image processing output data. The image processing output data may comprise an output indicating the presence of one or more object categories in the input image data in the case of an image classification task, or the image processing output data may comprise text describing the objects depicted in the input image data in the case of an image captioning task, or the image processing output data may comprise an output indicating an object category/instance that a pixel in the input image data belongs to in the case of an image segmentation or panoptic segmentation task. Further example tasks are described below.

An exemplary form of power law function will now be described. The power law function may be based upon the following form:

f(x,t)~αx^{a}+(βx^{b}+ξ)t^{c}+ϵ

where x is the architecture dimension; t is the computational resource utilization; α, β, ξ, ε, and b are parameters>0; a and c are parameters<0. Determining the power law function may comprise estimating the parameters α, β, ξ, ε, a, b, and c from the first plurality of neural network evaluations. Prior techniques have typically used a power law formulation that considers only a single architecture dimension or computational resource utilization in isolation rather than a joint form that takes account of both an architecture dimension and computational resource utilization as above. This joint form can enable improvements in both the efficiency of the overall procedure for determining a neural network architecture and for improving the task performance of the determined architecture.

Using the above exemplary power law function, for fixed compute t, the optimal value, x*, for the corresponding architecture dimension is:

$${x}^{*} = {( \frac{α \vert a \vert}{β {bt}^{c}} )}^{\frac{1}{b - a}}$$

which scales as O(t^{s}), where s=−c/(b−a).

In other words, the scaling exponent for an architecture dimension may be based upon the ratio: −c/(b−a). It will be appreciated that the scaling exponent is a positive value given that b>0 and a, c<0.

Whilst different performance metrics and tasks can result in fitting different parameters for the power law function, the use of the particular ratio is robust against different performance metrics and tasks. For example, in an image classification task using a Vision Transformer type neural network, scaling exponents for the width, depth and MLP size were derived as being approximately 0.22, 0.45 and 0.6 respectively. In another example, in a multi-modal, multi-task setting of image captioning, optical character recognition and question answering using a Vision Transformer type neural network and a performance metric of average perplexity score, the scaling exponents were derived as being approximately 0.25, 0.49 and 0.62 respectively.

The modification of the one or more architecture dimensions of the base neural network architecture 104 may be based upon distributing compute. For example, referring to the base neural network architecture as x(0) and its associated computational resource utilization as t(0), an increase in compute by a factor of τ, i.e. τ·t(0) may be accompanied by an increase in the value of an architecture dimension by a factor of τ^{(s}^{ₖ}^{/D)} where sₖ is the scaling exponent for architecture dimension k and D is the number of adjustable dimensions. As such, the compute scale factor (τ) may be determined by taking the ratio of the given computational resource constraint 101 and the computational resource utilization (t(0)) of the base neural network architecture 104 (x(0)). The dimensional scale factor may then be determined as τ^{(s}^{ₖ}^{/D)}, i.e. taking an exponential of the compute scale factor T with an exponent based upon the scaling exponent 102 sₖ. The corresponding architecture dimension of the base neural network architecture 104 may be scaled by the dimensional scale factor, for example, xₖ=τ^{(s}^{ₖ}^{/D)}·xₖ(0), where xₖ is the modified value of architecture dimension k from the base neural network architecture value xₖ(0).

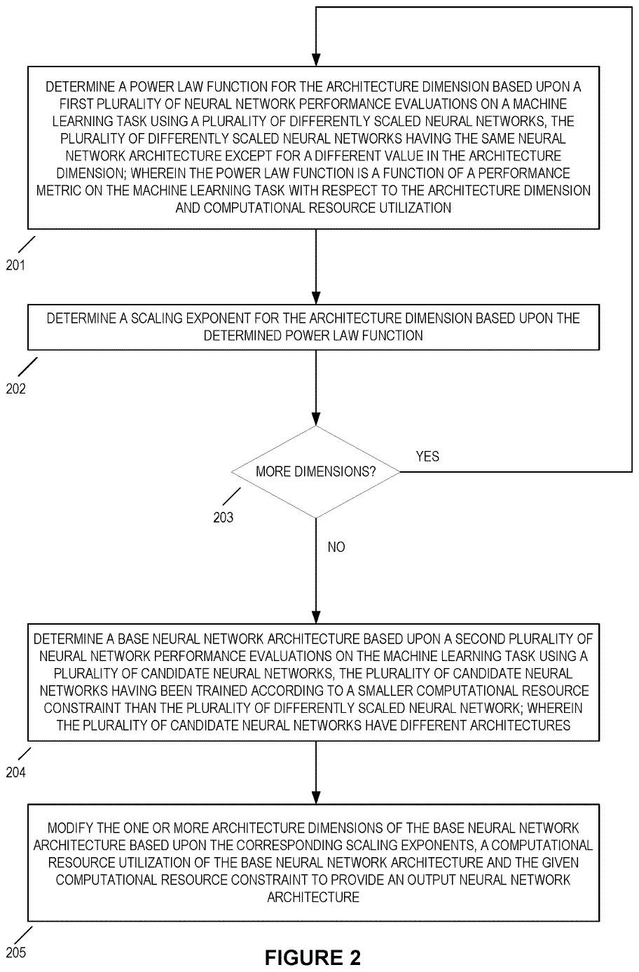

Referring now to FIG. 2, processing for determining a neural network architecture according to a given computational resource constraint will now be described. It will be appreciated that the processing may be implemented using the computing system 100 referred to above. As such, features described above in the context of the computing system 100 may combined as appropriate with features described in the context of the below processing.

At step 201, a power law function for an architecture dimension is determined based upon a first plurality of neural network performance evaluations on a machine learning task using a plurality of differently scaled neural networks. The plurality of differently scaled neural networks have the same neural network architecture except for a different value in the architecture dimension. The power law function is a function of a performance metric on the machine learning task with respect to the architecture dimension and computational resource utilization.

As described above, the plurality of differently scaled neural networks for all architecture dimensions may be based upon modifying a same starting architecture.

The different values of the architecture dimension in the plurality of differently scaled neural networks may be exponentially spaced apart. The plurality of differently scaled neural networks may have been trained according to the same computational resource constraint. The processing may optionally comprise training the plurality of differently scaled neural networks on the machine learning task. The machine learning task may be an image processing task or other suitable task.

At step 202, a scaling exponent is determined for the architecture dimension based upon the determined power law function. As described above, the power function may comprise a plurality of exponents and the scaling exponent for an architecture dimension may be based upon a ratio of the plurality of exponents. The power law function may be based upon the form:

f(x,t)~αx^{a}+(βx^{b}+ξ)t^{c}+ϵ

where x is the architecture dimension; t is the computational resource utilization; α, β, ξ, ε, and b are parameters>0; a and c are parameters<0. The scaling exponent for an architecture dimension may be based upon the ratio: −c/(b−a).

At step 203, it is determined whether there are any further adjustable architecture dimensions to be processed. If so, processing returns to step 201 in order to determine a power law function for another architecture dimension. For example, the one or more architecture dimensions that are to be adjusted may comprise a depth dimension and/or a width dimension. The neural network architecture may be based upon a Transformer architecture, such as a Vision Transformer. Where the neural network architecture is based upon the Transformer architecture, the one or more architecture dimensions may comprise a width of a multi-layer perceptron layer in a Transformer so block.

If it is determined that there are no further adjustable architecture dimensions to be processed, the operations proceed to step 204.

At step 204, a base neural network architecture is determined based upon a second plurality of neural network performance evaluations on the machine learning task using a plurality of candidate neural networks. The plurality of candidate neural networks have been trained according to a smaller computational resource constraint than the plurality of differently scaled neural networks and the plurality of candidate neural networks have different architectures. As described above, the base neural network architecture may be based upon an optimal architecture of the plurality of candidate neural networks with respect to performance and computational resource utilization.

As discussed above, each of the plurality of candidate neural networks may have an architecture with values in the one or more architecture dimensions that are smaller than the corresponding values of each of the plurality of differently scaled neural networks.

The plurality of candidate neural networks may have been trained according to different computational resource constraints. The processing may optionally comprise training the plurality of candidate neural networks on the machine learning task.

The architectures and/or the computational resource constraints of the plurality of candidate neural networks may be selected based upon a grid search.

At step 205, the one or more architecture dimensions of the base neural network architecture are modified based upon the corresponding scaling exponents, a computational resource utilization of the base neural network architecture and the given computational resource constraint to provide an output neural network architecture. As described above, modifying the one or more architecture dimensions of the base neural network architecture may comprise: determining a compute scale factor based upon the ratio of the given computational resource constraint and the computational resource utilization of the base neural network; determining a dimensional scale factor based upon taking an exponential of the compute scale factor with an exponent based upon the scaling exponent; and modifying the value of the corresponding architecture dimension of the base neural network by the dimensional scale factor. The exponent for taking an exponential of the compute scale factor may be based upon the value of the scaling exponent divided by the number of adjustable architecture dimensions.

The processing may further comprise training a neural network having an architecture of the output neural network architecture. The training may be on the same machine learning task as for determining the output neural network architecture. The processing may further comprise deploying a neural network having an architecture corresponding to the output neural network architecture (which may be the trained neural network). For example, on an image processing task, image data may be received and the image data processed using the neural network to generate image processing output data, such as a classification of an object depicted in the image.

It will be appreciated that whilst FIG. 2 shows a sequential ordering of steps, the processing of FIG. 2 need not be carried out sequentially. As discussed above, the determination of the power law function and scaling exponents for each architecture dimension (steps 201-203) and the determination of the base neural network architecture (step 204) are independent and may be carried out concurrently/in parallel or in a reversed order, i.e. step 204 may carried out before steps 201-203. Furthermore, within these steps, the evaluations of neural network performance may also be carried out in parallel. Where the neural networks undergo training, the training of neural networks may also be carried out in parallel. Each architecture dimension that is to be processed (steps 201 and 202) may also be carried out in parallel. Where operations occur in parallel, these may be implemented on a distributed system which may comprise neural network hardware acceleration units such as one or more Tensor Processing Units (TPUs), Graphics Processing Units (GPUs), Central Processing Units (CPUs), Application Specific Integrated Circuits (ASICs), and/or Field Programmable Gate Arrays (FPGAs), and/or one or more central processing units (CPUs).

As discussed above, the plurality of candidate neural networks may be pre-trained on a different machine learning task. The first and/or second neural network performance evaluations may be based upon a plurality of machine learning tasks.

Example tasks that a neural network may be trained to perform will now be described. It will be appreciated that the neural networks described above may be trained to perform any appropriate task and the below examples are illustrative and not intended to be limiting. The neural network may be configured to receive and process any type of digital input and to provide any type of digital output including a score, classification, or regression output. The input to and/or the output of the neural network may be sequential in nature as appropriate for the task.

In one example, a neural network may be configured to perform an image processing task. The neural network may be configured to receive and process image data as an input. The image data may comprise one or more values for each of a plurality of pixels, such as intensity values. Alternatively, the image data may comprise a low-level feature encoding of an image. The image data may comprise colour or monochrome data. The image data may captured by an image sensor of a digital camera, LIDAR, infra-red camera or any other camera type.

The image processing task may be an image classification task. The neural network may be configured to process input image data to provide an output indicating the presence of one or more object categories in the input image data. The indication may be a probability, a score or a binary indicator for a particular object category.

The image processing task may be an object detection task. The neural network may be configured to process input image data to provide an output indicating a location of one or more objects that have been detected in the input image data. The indication may be a bounding box, set of co-ordinates or other location indicator and the output may further comprise a label indicating the corresponding detected object.

The image processing task may be image segmentation. The neural network may be configured to process input image data to provide an output indicating an object category that a pixel (or each pixel) in the input image data belongs to.

The image processing task may be an image encoding task. The neural network may be configured to process input image data to provide a representation of the input image data. The representation may be a compressed encoding of the image data.

The image processing task may be a depth estimation task. The neural network may be configured to process input image data to provide an output indicating an estimated depth of objects depicted in the image data. The output may be a depth map comprising an estimated depth value for each pixel of the input image data.

The image processing task may be a captioning task. The neural network may be configured to process input image data to provide an output comprising a sequence of text in natural language describing the objects depicted within the image.

The image processing task may be a de-noising or in-filling task. The neural network may be configured to process input image data to provide as output a version of the input image data that has reduced noise or artefacts or has missing data imputed.

In another example, the neural network may be configured to receive and process audio data as an input. The audio data may comprise any type of digital audio signal and may comprise raw digital samples of a waveform (e.g. amplitude values) or may be an encoding derived from an audio signal such as a spectrogram, mel-frequency cepstral co-efficients or other acoustic features/time-frequency domain representation. The audio data may be obtained from an audio transducer such as a microphone.

The audio data may comprise a speech signal. The audio processing task may be a speech processing task such as speech recognition. The neural network may be configured to process an input speech signal to provide output data comprising one or more probabilities or scores indicating that one or more words or sub-word units comprise a correct transcription of the speech contained within. Alternatively, the output data may comprise a transcription itself.

The audio processing task may be a keyword (“hotword”) spotting task. The neural network may be configured to process input audio data to provide an indication of whether a particular word or phrase is spoken in the input audio data.

The audio processing task may be a speaker recognition or verification task. The neural network may be configured to process input audio data to provide an indication of the identity of a speaker or to provide an indication of whether a particular speaker is present in the audio data.

The audio processing task may be a language recognition task. The neural network may be configured to process input audio data to provide an indication or delineation of one or more languages present in the input audio data.

The audio processing task may be control task. The neural network may be configured to process input audio data comprising a spoken command for controlling a device to generate output data that causes the device to carry out actions corresponding to the spoken command.

In a further example, the neural network may be configured to receive and process text data. The neural network may be configured to perform a text-to-speech task. The neural network may be configured to process input text data to generate audio data comprising a spoken utterance corresponding to the input text data. This output audio data may be in a similar format to the input audio data for audio processing tasks described above.

The neural network may be configured to perform an image generation task. The neural network may be configured to process input text data to generate image data comprising objects corresponding to the input text data. The output image data may be in a similar format to the input image data for image processing tasks described above.

The neural network may be configured to perform a neural machine translation task. The neural network may be configured to process input text data comprising text in one language to provide output data comprising one or more probabilities or scores indicating that one or more words or sub-word units in a second language is comprised in a proper translation of the input text data into the second language. Alternatively, the output data may comprise the translation itself.

The neural network may be configured to process input text data comprising instructions for controlling a device to generate output data that causes the device to carry out actions corresponding to the instructions.

The neural network may be part of a dialogue system. The neural network may be configured to perform a conditional text generation task. The neural network may be configured to process input text data comprising a user prompt to provide output text data that is a response to the user prompt. The user prompt may be a question and the response may be an answer to the question. The user prompt may be a text description of the function of computer code and the response may be computer code in a programming language that is configured to perform the function. The user prompt may be an initial sequence of computer code in a programming language and the response may be a further sequence of computer code that completes the initial sequence to perform a particular function.

The neural network may be configured to perform a natural language processing or understanding task. For example, the task may be an entailment task, a paraphrase task, a textual similarity task, a sentiment task, a sentence completion task, a grammar task or other similar task.

In another example, the neural network may be configured to receive and process video data. The video data may comprise a plurality of frames, e.g. image data, and audio data. The above described image and audio processing tasks may therefore also be applicable to video data.

In addition, the neural network may be configured to perform an action recognition or detection task. The neural network may be configured to process input video data to provide an output indicating the detection of one or more actions being performed in the video data and/or the spatial and temporal locations of the detected actions within the video data. The indications may be a probability or score indicating a particular action has been detected, the spatial location may be a bounding box or co-ordinates in the frames of the video, the temporal location may be a set of timestamps or frame numbers of the video.

In another example, the neural network may be configured to receive and process digital documents. The digital document may be an Internet resource or one or more portions or features extracted from an Internet resource. The neural network may be configured to classify the document. The neural network may be configured to process the digital document to provide an output indicating a classification of the digital document. The indication may be a probability, a score or a binary indicator for a particular category. The classification may be a topic of the document.

The neural network may be configured to receive and process features of a personalized so recommendation for a user. For example, features characterizing the context for the recommendation such as features characterizing previous actions taken by the user. The neural network may generate an output comprising a probability or score for a particular content item representing the estimated likelihood that the user will respond favourably to being recommended the particular content item.

In another example, the neural network may be configured to perform a health prediction task. The neural network may be configured to receive and process electronic health record data. The neural network may be configured to generate an output comprising an indication of a diagnosis of a particular disease or health condition, or a prediction of the occurrence of an adverse health event, or a predicted treatment for the patient. The indication may be a probability or score.

In a further example, the neural network may be part of a data compression system. The neural network may be configured to process input data to provide a compressed version of the input data as output. The compressed data may be stored at an appropriate storage or memory device or transmitted to another device.

In another example, the neural network may be configured to perform a drug discovery task. The neural network may be configured to process a graph representing a molecule, a SMILES (Simplified Molecular Input Line Entry System) representation of a molecule, a DNA or RNA sequence, or text data describing one or more characteristics or properties of a molecule for synthesis to provide an output sequence representing a molecule for synthesis corresponding to the input data. A molecule may be synthesized according to the output sequence.

In another example, the neural network may be part of a reinforcement learning system. In general, in a reinforcement learning system an agent interacts with an environment in order to carry out a particular task. Observations characterizing the state of an environment may be received. The reinforcement learning system may select an action for an agent to perform based upon the received observations. The action performed by the agent may cause the environment to transition to a new state and the environment may provide a reward signal in response to agent's action. Further observations of the environment may be received and a new action may be selected based upon the further observations and the received reward if applicable. Actions for so the agent to carry out may be selected based upon a history of observations of the environment and actions performed by the agent.

The reinforcement learning system may be configured to select an action for an agent to perform based upon the output of the neural network. For example, the neural network may be a policy network and may be configured to process the observation characterizing the state of the environment to provide a probability distribution (or set of scores) over a set of possible actions. An action may be selected by sampling an action from the probability distribution or the action with the highest probability/score may be selected. The reinforcement learning system may cause the agent to perform the selected action. Neural networks in reinforcement learning systems may perform other functions such as provide an estimate of the value of a being in a given state of the environment, provide an estimate of the value of carrying out a particular action, provide a model of the environment to predict state transitions and observations, or provide an estimate of the reward function of an environment amongst others. It will be appreciated that in all these cases, whilst a neural network may not directly select an agent action, the output of the neural network feeds into the process for the selection of an action.

The environment may be a real-world environment. The agent may be a mechanical or electronic agent interacting with the real-world environment to carry out a particular task. For example, the agent may be a robot or (semi-)autonomous vehicle operating on land, sea and/or air. The agent may be tasked with navigating to a specified destination in the environment. The agent may be tasked with locating an object of interest in the environment. The agent may be tasked with moving an object of interest in the environment to a specified destination.

The observations of the environment may include image data, positional/location data of objects in the environment, including the agent, and/or sensor data. The sensor data may include data from cameras, distance sensors, position sensors, temperature sensors, sensors monitoring the state of components on the agent or in the environment amongst others. The observations may include data characterizing the state of the agent such as, position, linear or angular velocity, force, torque, acceleration, a global or relative pose of the agent or parts of an agent or objects in relation to the agent where appropriate. The observations may be in any number of dimensions and may be absolute or relative observations.

The actions may be control signals to the control the agent such as data indicating a position, velocity, force, torque, acceleration, angles, voltage or current for the agent or components of the agent such as joints, motors, steering, brakes. Alternatively, the actions may be higher-level commands that an agent can interpret and convert to low-level control signals to execute the higher-level command.

In another example, the environment may be a real-world manufacturing environment for the manufacture of a product. The product may be any type of product such as a mechanical, chemical, biological or food product. Manufacturing may include any kind of process applied to a product such as treating a product to apply a coating, cleaning the product, deconstructing a product or any transformation of a product or materials. Manufacturing may also include the manufacture of intermediate elements. A manufacturing plant may comprise a plurality of manufacturing units including apparatus for chemical or biological processes and machines, including robots, for processing materials. The manufacturing plant may be configured to move intermediate elements between manufacturing units, such as using an assembly line or other methods of conveyance. Manufacture of a product may include the manufacture of a food product by a kitchen robot, e.g. cooking.

An agent be a mechanical agent as described above, such as, a robot used in the manufacturing process. Alternatively, the agent may comprise an electronic agent configured to control one or more manufacturing units and/or parameters of a manufacturing process. The agent may comprise a control system configured to control the manufacturing process. The agent may be tasked with the manufacture of a product whilst minimizing resource usage such as electricity or water consumption and the consumption of materials and other consumables used in the manufacturing process.

The reward may be based upon a metric measuring task performance. For example, the metric may measure the quality of the manufactured product, the manufacturing speed, the consumption of resources, or other physical costs.

The observations may include sensor data for monitoring the manufacturing process such as monitoring the state or configuration of materials, machines, processes and working environments. The sensors may be configured to sense mechanical movement or force, pressure, temperature; electrical conditions such as current, voltage, frequency, impedance; quantity, level, flow/movement rate or flow/movement path of so one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The agent actions may manipulate the manufacturing process to alter such states. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In a further example, the environment may be a real-world environment comprising a service facility comprising a plurality of items of electronic equipment, such as a server farm or data centre, for example, a telecommunications data centre, or a computer data centre for storing or processing data, or any service facility. The service facility may also include ancillary control equipment that controls an operating environment of the items of equipment, for example, environmental control equipment such as temperature control e.g. cooling equipment, or air flow control or air conditioning equipment. The agent may be tasked with the operation of the service facility whilst minimizing resource usage such as electricity or water consumption. The reward may be based upon a metric measuring task performance. For example, the metric may measure the load or throughput of the facility, or the consumption of resources such as electricity, water or other materials such as consumables. The agent may comprise an electronic agent configured to control operation of the items of equipment, or to control operation of the ancillary, e.g. environmental, control equipment.

The observations may comprise any electronic signals representing the functioning of the facility or of equipment in the facility. For example, the observations may be obtained from sensors sensing a state of a physical environment of the facility or sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The actions may be any actions that have an effect on the observed state of the environment, e.g. actions configured to adjust any of the sensed parameters. These may include actions to control, or to impose operating conditions on, the items of equipment or the ancillary control equipment, e.g. actions that result in changes to settings to adjust, control, or switch on or off the operation of an item of equipment or an item of ancillary control equipment.

In another example, the environment may be a real-world environment comprising a power generation facility, for example, a renewable power generation facility such as a solar farm or wind farm. The agent may be tasked to control the power generation facility, for example to optimize the times at which certain generation units are switched on or off to meet demand, and/or to control delivery of electricity to a power distribution grid. The reward may be based upon a metric measuring task performance. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, so frequency or phase of electrical power generated.

The observations may comprise any electronic signals representing the electrical or mechanical functioning of power generation equipment in the power generation facility. For example, the observations may be obtained from any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations may also comprise one or more predictions regarding future conditions of operation of the power generation equipment such as predictions of future wind levels or solar irradiance or predictions of a future electrical condition of the grid.

In a further example, the environment may be a chemical synthesis or protein folding environment such that each state is a respective state of a protein chain or of one or more intermediates or precursor chemicals. The agent may be a computer system for determining how to fold the protein chain or synthesize the chemical. The actions may be possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation. In a similar way, the environment may be a drug design environment such that each state is a respective state of a potential pharmachemical drug. The agent may be a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In another example, an agent may manage distribution of tasks across computing resources e.g. on a mobile device and/or in a data centre. The actions may include assigning tasks to particular computing resources. The reward may be based upon a load, latency, or throughput of the device or data centre and/or resource consumption such as power.

In another example, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

In some implementations, the environment may be a simulation of the above described real-world environments. The simulation may be used to train the reinforcement learning system for example. This can avoid unnecessary wear and tear and damage to the real-world environment or real-world agent and can allow the system to be trained and evaluated on situations that occur rarely or are difficult or unsafe to re-create in the real-world environment. For example, the system may be partly trained using a simulation of the agent in a particular real-world environment, and afterwards deployed to control the real agent in the particular real-world environment. Thus, in such cases the observations of the simulated environment relate to the real-world environment, and the selected actions in the simulated environment relate to actions to be performed by the mechanical agent in the real-world environment.

In a further example, the environment may be an electrical, mechanical or electromechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The reward may comprise one or more metrics of performance of the design of the entity. For example, the reward may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus, a design process of an entity may be optimized, e.g. by reinforcement learning, and then the optimized design output for manufacturing the entity, e.g. as computer executable instructions; an entity with the optimized design may then be manufactured.

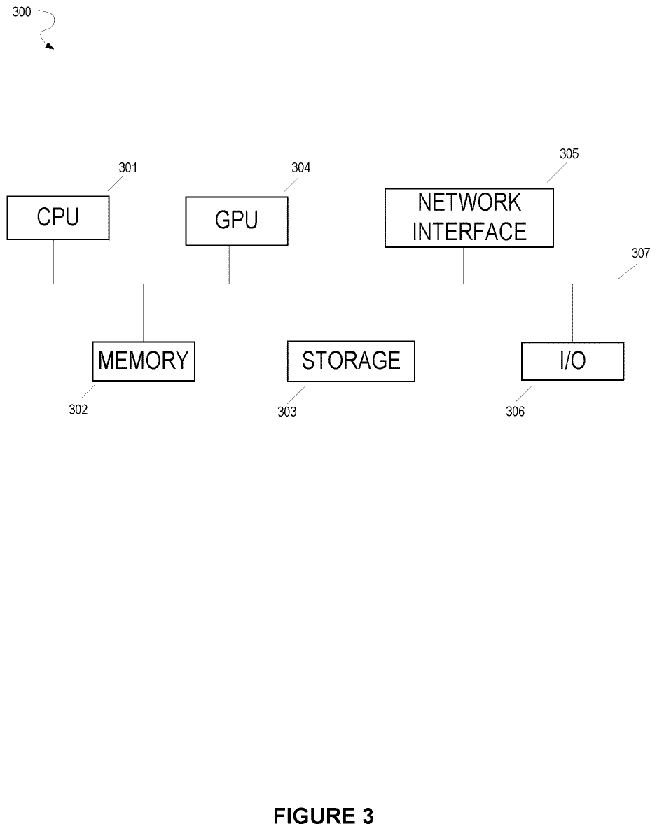

FIG. 3 shows a schematic illustration of an exemplary computer apparatus 300. The computer apparatus 300 comprises a central processing unit (CPU) 301. The computer apparatus 300 may comprise a plurality of CPUs and/or the CPU may comprise a plurality of processing units. The CPU 301 is configured to execute processable readable instructions to carry out operations such as those of a corresponding computer program.

The computer apparatus 300 further comprises a memory 302. The memory 302 may be a volatile memory such as RAM and may comprise a plurality of memory devices. Alternatively, or in addition, the memory 302 may comprise non-volatile memory such as ROM. The memory 302 may be configured to store instructions of a computer program for the CPU 301 to execute. The memory 302 may be configured to store data that the CPU 301 is configured perform operations on.

The computer apparatus 300 also comprises one or more storage devices 303. The one or more storage devices 303 may be non-volatile and may be configured to store user data for example. The one or more storage devices 303 may comprise a hard disk drive (HDD), solid state drive (SSD) and/or any other storage devices including portable storage devices such as removeable USB drives and SD cards or devices for reading from removeable media such as CD-ROM, DVD-ROM, Blu-ray and other disks.

The computer apparatus 300 further comprises a graphics processing unit (GPU) 304. In some implementations, a CPU 304 is integrated with the CPU 301 rather than being a separate component. The CPU 304 is configured to provide output for a (graphical) user interface of the computer apparatus 300. In some implementations, the GPU 304 may be configured to operate as a neural network hardware acceleration unit for carrying out neural network operations.

The computer apparatus 300 also comprises one or more network interfaces 305. The one or more network interfaces 305 may comprise a wired interface such as Ethernet, and/or a wireless interface such as Wi-Fi or Bluetooth for connecting to any type of network including a local area network (LAN) such as an intranet, a wide area network (WAN) such as the Internet or a cellular network. The computer apparatus 300 may be configured to receive data from a network and/or transmit data to the network via the network interface 305.

The computer apparatus 300 further comprises an input/output (I/O) interface 306. The I/O interface 306 may be configured to provide communication with one or more devices for receiving user input such as a keyboard, mouse, trackball, touchscreen, gesture-based interfaces or other appropriate input device. The I/O interface 306 may be configured to provide output to a connected output device such as a monitor.

The computer apparatus 300 comprises one or more buses 307 to provide communication between the various elements of the computer apparatus 300.

The computer apparatus 300 may be an exemplary implementation of the computing system 100 of FIG. 1.

Specific embodiments of the subject-matter have been described. It will be appreciated that the described embodiments are to be considered exemplary and non-limiting and that other embodiments will fall within the scope of the appended claims. For example, actions described as being carried out in a particular order may be carried out in a different order. Actions shown as being sequential may be carried out in parallel or using a combination of parallel and serial processing. Where a specific arrangement is described for carrying out a particular function, other suitable arrangements for carrying out the particular function may also fall within the scope of the claims. For example, actions carried out by a plurality of modules may be carried out by a singular module and vice versa.

1. A computer-implemented method for determining a neural network architecture according to a given computational resource constraint, the method comprising:
for each of one or more neural network architecture dimensions that are to be adjusted:
determining a power law function for the architecture dimension based upon a first plurality of neural network performance evaluations on a machine learning task using a plurality of differently scaled neural networks, the plurality of differently scaled neural networks having the same neural network architecture except for a different value in the architecture dimension;
wherein the power law function is a function of a performance metric on the machine learning task with respect to the architecture dimension and computational resource utilization; and
determining a scaling exponent for the architecture dimension based upon the determined power law function;
determining a base neural network architecture based upon a second plurality of neural network performance evaluations on the machine learning task using a plurality of candidate neural networks, the plurality of candidate neural networks having been trained according to a smaller computational resource constraint than the plurality of differently scaled neural networks;
wherein the plurality of candidate neural networks have different architectures; and
modifying the one or more architecture dimensions of the base neural network architecture based upon the corresponding scaling exponents, a computational resource utilization of the base neural network architecture and the given computational resource constraint to provide an output neural network architecture.

2. The method of claim 1, wherein the power law function comprises a plurality of exponents and the scaling exponent for an architecture dimension is based upon a ratio of the plurality of exponents.

3. (canceled)

4. (canceled)

5. The method of claim 1, wherein the base neural network architecture is based upon an optimal architecture of the plurality of candidate neural networks with respect to performance and computational resource utilization.

6. The method of claim 1, wherein modifying the one or more architecture dimensions of the base neural network architecture comprises:
determining a compute scale factor based upon the ratio of the given computational resource constraint and the computational resource utilization of the base neural network;
determining a dimensional scale factor based upon taking an exponential of the compute scale factor with an exponent based upon the scaling exponent; and
modifying the value of the corresponding architecture dimension of the base neural network by the dimensional scale factor.

7. (canceled)

8. The method of claim 1, wherein the plurality of differently scaled neural networks for all architecture dimensions are based upon modifying a same starting architecture.

9. The method of claim 1, wherein the different values of the architecture dimension in the plurality of differently scaled neural networks are exponentially spaced apart.

10. The method of claim 1, wherein the plurality of differently scaled neural networks have been trained according to the same computational resource constraint.

11. The method of claim 1, wherein each of the plurality of candidate neural networks has an architecture with values in the one or more architecture dimensions that are smaller than the corresponding values of each of the plurality of differently scaled neural networks.

12. The method of claim 1, wherein the plurality of candidate neural networks have been trained according to different computational resource constraints.

13. The method of claim 1, wherein the architectures and/or the computational resource constraints of the plurality of candidate neural networks are selected based upon a grid search.

14. The method of claim 1, wherein the plurality of candidate neural networks are pre-trained on a different machine learning task.

15. The method of claim 1, wherein the first and/or second neural network performance evaluations are based upon a plurality of machine learning tasks.

16. The method of claim 1, further comprising training the differently scaled and/or plurality of candidate neural networks.

17. The method of claim 1, wherein the one or more architecture dimensions that are to be adjusted comprises a depth dimension and/or a width dimension.

18. The method claim 1, wherein the neural network architecture is based upon a Transformer architecture, and wherein the one or more architecture dimensions comprises a width of a multi-layer perceptron layer in a Transformer block.

19. (canceled)

20. (canceled)

21. The method of claim 1, wherein the machine learning task is an image processing task.

22. The method of claim 1, further comprising:
training a neural network having an architecture of the output neural network architecture.

23. The method of claim 1, further comprising:
receiving image data; and
processing the image data using a neural network to generate image processing output data; wherein the neural network has an architecture corresponding to output neural network architecture.

24. (canceled)

25. A system comprising:
one or more processors; and
one or more computer readable storage media comprising processor readable instructions to cause the one or more processors to carry out operations, the operations comprising:
for each of one or more neural network architecture dimensions that are to be adjusted:
determining a power law function for the architecture dimension based upon a first plurality of neural network performance evaluations on a machine learning task using a plurality of differently scaled neural networks, the plurality of differently scaled neural networks having the same neural network architecture except for a different value in the architecture dimension;
wherein the power law function is a function of a performance metric on the machine learning task with respect to the architecture dimension and computational resource utilization; and
determining a scaling exponent for the architecture dimension based upon the determined power law function;
determining a base neural network architecture based upon a second plurality of neural network performance evaluations on the machine learning task using a plurality of candidate neural networks, the plurality of candidate neural networks having been trained according to a smaller computational resource constraint than the plurality of differently scaled neural networks;
wherein the plurality of candidate neural networks have different architectures; and
modifying the one or more architecture dimensions of the base neural network architecture based upon the corresponding scaling exponents, a computational resource utilization of the base neural network architecture and the given computational resource constraint to provide an output neural network architecture.

26. One or more non-transitory computer readable storage medium comprising instructions which, when executed by a computer, cause the computer to carry out operations, the operations comprising:
for each of one or more neural network architecture dimensions that are to be adjusted:
determining a power law function for the architecture dimension based upon a first plurality of neural network performance evaluations on a machine learning task using a plurality of differently scaled neural networks, the plurality of differently scaled neural networks having the same neural network architecture except for a different value in the architecture dimension;
wherein the power law function is a function of a performance metric on the machine learning task with respect to the architecture dimension and computational resource utilization; and
determining a scaling exponent for the architecture dimension based upon the determined power law function;
determining a base neural network architecture based upon a second plurality of neural network performance evaluations on the machine learning task using a plurality of candidate neural networks, the plurality of candidate neural networks having been trained according to a smaller computational resource constraint than the plurality of differently scaled neural networks;
wherein the plurality of candidate neural networks have different architectures; and
modifying the one or more architecture dimensions of the base neural network architecture based upon the corresponding scaling exponents, a computational resource utilization of the base neural network architecture and the given computational resource constraint to provide an output neural network architecture.
